(19) United States
(12) Patent Application Publication
(10) Pub. No.: US 2008/0289525 A1
(43) Pub. Date: Nov. 27, 2008

(54) Driving System for the Cylinder Cleaning Assemblies of Printing Machines

(76) Inventors: Marco Corti, Lecco (IT); Riccardo Fumagalli, Lecco (IT)

Correspondence Address: STITES & HARBISON PLLC, 1199 NORTH FAIRFAX STREET, SUITE 900, ALEXANDRIA, VA, 22314, US

(21) Appl. No.: 12/096,146

(22) PCT Filed: Dec. 9, 2005
(86) PCT No.: PCT/EP05/56634

§ 371 Date: Jun. 4, 2008

(51) Int. Cl. B41F 35/00

(52) U.S. Cl. 101/423

(57) ABSTRACT

When the plate cylinder (D) is provided with at least one longitudinal channel (C) housing the sheet grippers (P) and when the ends of this channel have cams (Z) for contact with rollers mounted on the cleaning assembly, to ensure that when this assembly is actively working the presser (6) and cloth (T) do not interfere with the said grippers as they pass the said channel (C), the shoulders (2) of the said cleaning assembly are held stationary and the said cams (Z) of the cylinder (D) contact directly, or via interposed means, rollers (20) located at the ends of the presser (6), in such a way as to move only this component rather than the whole cleaning assembly as in the prior art. Compensating means are provided to cause the active length of cloth to remain suitably tensioned in the longitudinal direction and promptly to follow the presser's (6) movements of extension and retraction. When the end rollers of the presser are actuated by the interposition of pairs of pivoting levers (22, 25), arrangements are made to enable these pairs of levers to contact the cam (Z) located on one side only of the plate cylinder, the levers being connected to each other by at least one torsion bar (31).

The invention relates to cylinder cleaning assemblies for printing machines, comprising a bar parallel to the cylinder which is to be cleaned. This bar is positioned a short distance from the cylinder and its front face turned towards the cylinder contains a straight longitudinal slot in which is guided a presser fitted on its outer front face with a soft elastomeric insert. Housed inside the bar are pneumatic actuators which push the presser elastically and in a distributed manner against the cylinder that is to be cleaned, to maintain in contact therewith a corresponding portion of fabric or cloth which has first been sprayed with cleaning fluids by a row of nozzles or holes set in the same front face of the bar which is turned towards the cloth. The said bar is connected at each end to a pair of shoulders which also rotatably support the ends of a pair of spools, one paying out and the other winding up the said cleaning cloth.

When the above assembly is intended for cleaning plate cylinders with sheet grippers, at the current time the shoulders of the assembly are designed to be advanced towards and drawn back from the cylinder, for example by track and runner means or pivoting means and pneumatic actuators, to move from a rest position in which there is no interference between the presser and cloth on the one hand and the cylinder on the other, to an active position in which, pushed by the presser, the cloth contacts the cylinder, which as it rotates transfers its dirt to the cloth and becomes clean. At the ends of the transverse slot housing the sheet grippers, the cylinder is equipped with cams which are usually in relief relative to the circumference of the cylinder, while the assembly shoulders are provided with rollers which, when contacted by the said cams, move the complete assembly temporarily and in phase away from the cylinder as it passes the channel with the grippers, to avoid harmful interference of the cloth and presser with the grippers. This design has limits due to the large mass of the assembly that has to be moved cyclically by the cams.

It is an object of the invention to obviate these limits of the prior art, with the following idea for resolution. The shoulders of the assembly are fixed to the shoulders of the printing machine, or at any rate kept still, and the rollers which contact the said cams are mounted at each end of the presser, in such a way that as it passes the channel with the grippers of the cylinder being cleaned, only the presser with its limited mass is moved. This represents a considerable simplification and shortening of the amount of time required to carry out the cylinder cleaning process. The presser movement is controlled by the pneumatic actuators which enable it to maintain contact elastically with the plate cylinder and if the travel of these actuators is comparatively large, a portion of the length of cloth stretched between the paying out and winding up spools and located upstream or downstream of the presser is passed around the take up dancer which winds up the cloth when the presser moves from the active to the rest position and releases cloth when the presser travels in the opposite direction.

Other features of the invention, and the advantages which it provides, will become clear in the course of the following description of a preferred embodiment thereof, illustrated purely by way of non restrictive example in the figures of the three attached sheets of drawings, in which:

FIGS. 1, 2 and 3 show in transverse section a cleaning assembly according to the invention shown with the presser at rest, in the active position on the cylinder to be cleaned, and acted upon by the cams mounted at the ends of the channel of the cylinder with the grippers;

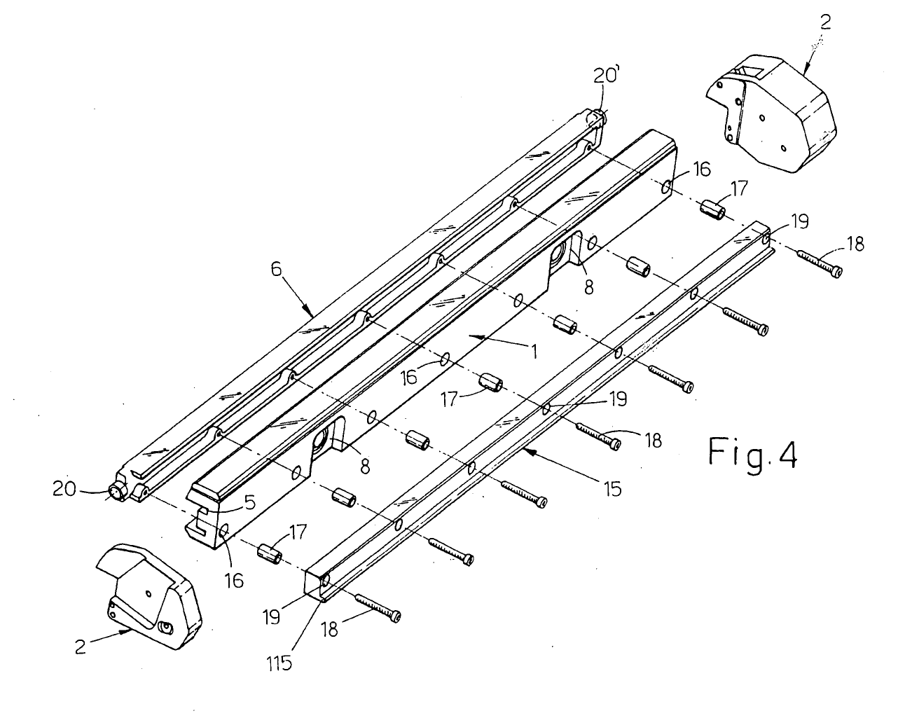

FIG. 4 shows the cleaning assembly in perspective, broken down into its main components; and

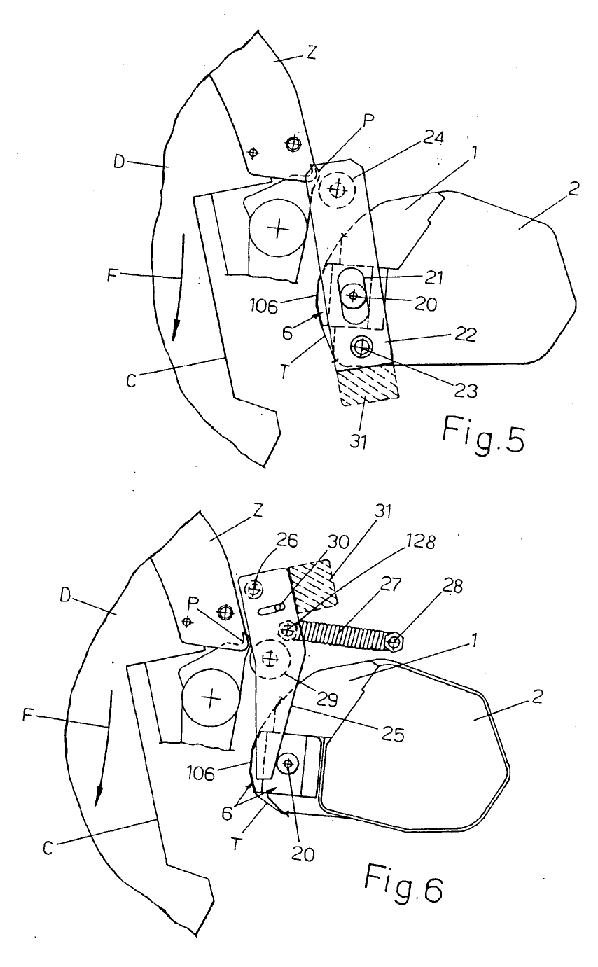

FIGS. 5 and 6 are diagrammatic views inside elevation of the alternative embodiments of the assembly.

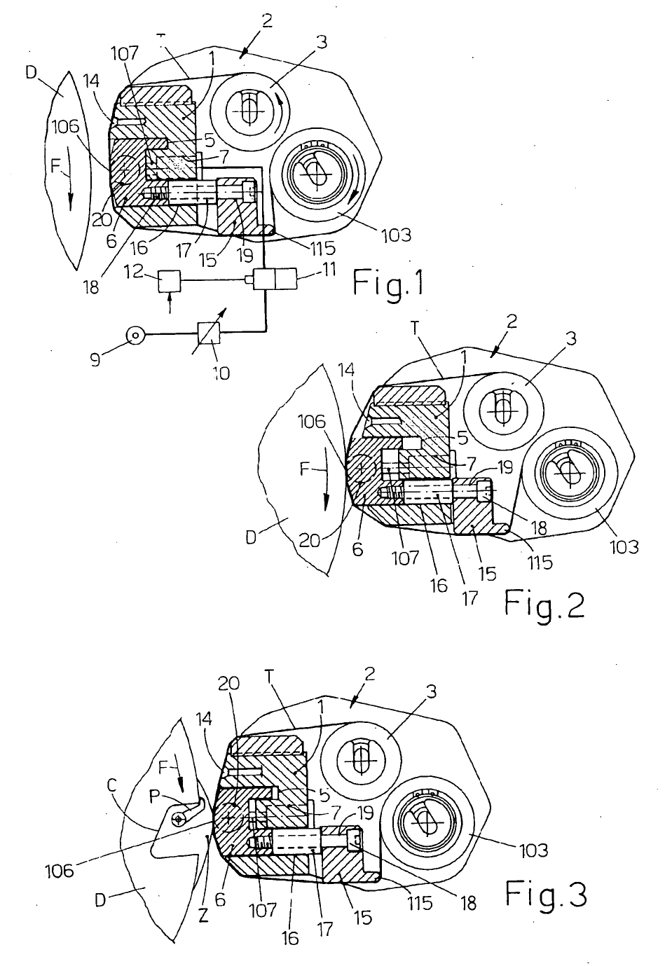

In FIG. 1 the letter D indicates the printing machine cylinder containing a transverse channel C housing the sheet grippers P which can be withdrawn into the said channel or project partially from it. At the ends of the channel C there are mounted on the plate cylinder with the usual amount of projection or otherwise from the circumference of the cylinder, the cams Z which serve to prevent interference between the cleaning assembly and the said grippers P. Parallel to the cylinder D is the cleaning assembly bar 1 whose ends are connected to a pair of shoulders 2 which in accordance with the invention may be fixed for example to the shoulders of the printing machine. These shoulders support, parallel to the said bar, upstream and downstream of the bar, the spools 3 and 103 which respectively pay out and wind up the cloth T which is passed around the said bar. The spindle of the spool 3 may be controlled for example by friction means and on command can be arrested by known means, while the spindle of the spool 103 is connected to known means (also not shown) of unidirectional and irreversible rotation which may for example operate in the clockwise direction. As it is fed around the bar 1, the cloth T passes over a straight slot 5 in which is mounted, in such a way as to be able to move transversely, the presser 6 which touches the cloth with its active part 106. The latter is made of a suitable soft elastic material and is connected at the rear to the rod 107 of at least two linear actuators 7 consisting for example of pneumatically actuated cylinder and piston units whose bodies are fixed in seats 8 formed in a suitable symmetrical arrangement on the rear face of the bar 1, as in FIG. 4. The cylinder and piston units 7 may for example be of the single acting type, with rod retraction by elastically acting means or may be of the double acting type and are connected to a compressed air supply 9, via a pressure regulator 10 and a solenoid valve 11 controlled by a small processor 12 which controls the cleaning cycle of the cylinder D. The rod of each actuator 7 is normally retracted as in FIG. 1 in order to keep the presser 6 retracted into its slot 5, but when commanded by the processor 12 the actuators 7 can be extended to move the active part 106 of the presser 6 into contact, through the cloth T, with the cylinder D to be cleaned which is rotating, for example, in the direction of arrow F of (FIG. 2). Upstream of the slot 5 the bar 1 contains a row of holes or nozzles indicated diagrammatically by the number 14, which on command release onto the cloth T a cleaning fluid consisting for example of a mixture of water and solvent transported by compressed air.

In a preferred embodiment of the invention, a portion of the length of cloth T stretched between the spools 3 and 103 and located upstream or downstream of the presser 6, e.g. a portion of the length of dirty cloth lying between the presser 6 and the winding up spool 103, also travels around the rounded edge 115 of a beam 15 which has a dancer function, as described in Italian patent application No GE 99A 125, which may for example be of generally L cross section (see also FIG. 4) and parallel to and on the opposite side from the presser 6 which in turn contains in its lower part a plurality of suitably spaced-out round sectioned holes 16. Hollow cylindrical distance pieces 17 slide axially in these holes and contain screws 18 which in turn pass through corresponding holes 19 in the said beam 15 to connect the said beam to the rear of the body of the presser 6 so that they move together as one. The distance pieces 17 can slide with play in the corresponding holes 16 of the bar 1, in such a way that the presser automatically and accurately adjusts itself when in contact with the plate cylinder, even if the assembly has not been set up very carefully. If on the other hand the assembly can be set up accurately at least in terms of the presser being parallel to the generatrix of the cylinder D, some or all of the distance pieces 17 can slide in their holes 16 with a guided action and the distance pieces may be made of a material with a low coefficient of friction and/or the said holes 16 may be fitted with bushes of a material with a low coefficient of friction or with small ball-recirculating bearings (not shown), to produce an efficient guidance system for the presser 6 which, partly owing simply to the connection via the distance pieces 17 and the screws 18 to the beam 15, is stiffened against bending and remains perfectly straight and parallel to the generatrix of the cylinder D, even if pressed against the latter by only two actuators 7 arranged symmetrically and at a distance from each other. When the assembly is at rest as in FIG. 1, with the presser 6 retracted into its seat 5, the beam 15 is at its furthest position from the bar 1.

The present assembly is completed by the rollers 20, 20′ mounted rotatably on the ends of the presser 6. Their axis lies on the longitudinal axis of the presser 6 and they are positioned so as to be able to be contacted, when required, by the cams Z of the plate cylinder D.

The manner in which the assembly thus designed works is simple and obvious. When the assembly is in the rest position as in FIG. 1, a clean length of cloth T is fed to the presser 6, while the spindle of the spool 3 is for example restrained by friction and the spool 103 turns clockwise. During this time the dancer 15 is in the extended position, forcing the length of cloth stretched between the spool 103 and the bar 1 to follow a dog-leg path that is longer than would be the case it the dancer was up against the bar 1 (FIG. 2). During this period the nozzles or holes 14 spray the cleaning fluid onto the length of cloth that is passing in front of them and that positions itself in front of the active part 106 of the presser 6. When the cloth is in place, the spindle of the spool 3 is locked, the motor of the spool 103 stops irreversibly, and when the actuators 7 are activated to move the presser 6 with its active part 106 into contact, through the cloth T, with the cylinder D to be cleaned, which continues to rotate at the correct speed in the direction of arrow F, the dancer 15 simultaneously retreats with the bar 1, as in FIG. 2. The dimensions of the apparatus are chosen so that the shortening of the length of cloth T stretched between the dancer 15 and the spool 103 owing to the retraction of the dancer, is approximately equal to the increase in the length of cloth stretched between the spool 3 and the same dancer 15 owing to the forward movement of the presser 6. When the end rollers 20, 20′ of the presser 6 are contacted by the cams Z of the cylinder D, during the passage over the channel C with the grippers P (FIG. 3), the presser 6 is usually drawn back slightly from the cylinder D, counter to the elastic action of the compressed air in the actuators 7, and the dancer 15 promptly takes up all the slack in the cloth which would otherwise be caused by the retraction of the presser, thereby preventing interference between the cloth and the grippers P. In this phase, in order to limit the impact and pressure of the rollers 20, 20′ against the cams Z, optional means may be provided to limit the pressure of the actuators 7, e.g. means which act automatically on the pressure regulator 10 and/or other suitable means acting in phase with the rotation of the cylinder D. When the cleaning phase is finished and the presser 6 returned by the actuators 7 to the rest position as in FIG. 1, the cloth promptly follows the retraction of the said presser because the increase in the length of cloth stretched between the dancer 15 and the spool 103, caused by the extension of the said dancer, is approximately equal to the shortening of the length of cloth stretched between the spool 3 and the dancer 15. It will be obvious that, with the solution described, the cloth follows the presser 6 promptly during the movements of extension and retraction, even if these are large, and that the length of the cloth stretched between the spools 3, 103 is always correctly tensioned and never subjected to anomalous longitudinal tensions; so that whenever the winding up spool 103 pulls in a length of dirty cloth, a corresponding length of clean cloth is unwound from the paying out spool 3 and positioned over the presser 6, throughout which period this length of cloth is always kept under firm longitudinal tension and is held tightly over the front face of the bar 1, which contains the open holes or nozzles 14 through which the cleaning fluid is distributed, thereby avoiding all the disadvantages of the prior art.

The scope of the invention also includes the solution, not shown in the drawings, whereby the cleaning assembly as described can be used alternatively for cleaning two neighbouring plate cylinders. In this case the assembly's shoulders 2 are not fixed to the shoulders of the printing machine but are mounted on the latter's shoulders or on some other supporting structure and can be rotated on command about an axis parallel to the longitudinal axis of the bar 1, as a result of the action of a suitable actuator. This is done in such a way that the active front face 106 of the presser 6 can be correctly oriented against either of the two cylinders to be cleaned. The same scope of the invention also covers the variants described below with reference to FIGS. 5 and 6, in which the end rollers 20, 20′ of the presser 6 are contacted by the cams Z with interposed means, such as pivoting lever means, which are able to position the said cams away from the ends of the channel C of the cylinder containing the grippers P, and/or to handle other mounting requirements which cannot use the direct contact between the rollers 20, 20′ and the cams Z. In the FIG. 5 version, the end rollers 20, 20′ of the presser make contact with for example the intermediate openings 21 of respective levers 22 pivoting via an end at 23 on the body 1 or on the shoulders 2 of the cleaning assembly. At the other end of each lever 22 is a roller 24 located so as to read the profile of the cams Z which in this example, assuming the cylinder D to be rotating in the direction of arrow F, are located immediately downstream of the channel C, to avoid interference with the active front face 106 of the presser 6 as it passes over the highest part of grippers P. If the cleaning assembly is intended to work selectively on two or more neighbouring plate cylinders, the assembly of FIG. 5 will move at the same time as its levers 22 with the roller 24 reading the cams Z of one or other of the said cylinders.

In the FIG. 6 version, each end roller 20, 20′ of the presser 6 contacts the end of a lever 25 whose opposite end is pivoted at 26 to, for example, the shoulders of the frame of the printing machine or to another fixed support which by means of an elastically acting means 27 attached by end 28 to the said shoulders and by the other end 128 to an intermediate point on the said lever, keeps the said lever in constant contact with its respective roller 20, 20′. In the intermediate part of the lever 25 is a roller 29 positioned so as to read the profile of the cams Z which in this example is again located immediately downstream of the channel C to prevent interference by the active front face 106 of the presser 6 as it passes over the projecting part of the grippers P. If the cleaning assembly in FIG. 6 is intended to work selectively on two or more neighbouring plate cylinders, the one assembly will move independently of the levers 25, which will be provided with a device containing an opening and a fixed pin 30 to limit the pivoting of the levers in contrast to the action of the spring 27 and to keep the lever in the appropriate position to move back into contact with the end roller 20 or 20′ of the presser any time the assembly moves back to the plate cylinder from which it had previously moved away. In this case, each plate cylinder is provided with respective levers 25 as shown in FIG. 6. When deciding the dimensions and profiles of the cams Z for versions of the type illustrated in FIGS. 5 and 6, it will obviously be necessary also to take into account the manner of operation of the levers 22 (disadvantageous) and of the levers 25 (advantageous).

The versions shown in FIGS. 5 and 6 lend themselves to operating the pairs of levers 22 or 25 which act on the end rollers 20, 20′ of the presser 6 with a single cam Z mounted on one side of the plate cylinder D. This greatly simplifies the construction and improves the flexibility of use of the assembly. To achieve this object, the levers 22 or 25 mounted at opposite ends of the unit 1, 2 are connectively gathered by at least one torsion bar 31 which may be close and parallel to the respective pivots 23 and 26, as in the examples illustrated, or which may contain and in part form these pivots, as those skilled in the art will appreciate and will have no difficulty carrying out. In the FIG. 5 version, only one of the levers 22 carries at its end the roller 24 for contacting the cam Z, which itself is located on only one side of the cylinder D, while the other lever 22 will not have the roller 24 and can be shorter than the other, it being intended to contact only the end roller 20′ of the presser. In the FIG. 6 version, only one of the levers 25 will have the intermediate roller 29 for contacting the cam Z, which itself is located on only one side of the plate cylinder. In this case both levers 25 are of the same length.

It will be understood that if the grippers P do not project from the channel C of the plate cylinder, or project by a small amount, and if the cleaning assembly can be located very close to the cylinder D, so that the presser 6 has to move a few millimetres from the rest position to the extended position and back again, including when contacting the cams Z of FIG. 3, the dancer 15 may be omitted because it will be possible to make use of the longitudinal elasticity given to the cloth by its relatively slack winding onto the spools 3 and/or 103, or it will be possible to make use of the action of suitable elastically acting means located between the spindle of this spool 103 and its drive means or by using a drive means of this type with elastic reaction.

It will be understood that the description has omitted the supply means of the nozzles 14 and the means that control the spindles of the spools 3 and 103, on the grounds that these are known and easily produced by those skilled in the art. Lastly, it will be understood that the description has referred to a preferred embodiment of the invention, to which many alterations and modifications can be made, especially in terms of construction, these referring for example to the fact that the beam 1 may be provided with a rotatable wheel for contact with the cloth T. In other variants, the dancer 15 could be activated indirectly by the presser 6. The dancer could be mounted on the bar 1 in a guided manner as in the version depicted, but with no mechanical connection to the presser, or could be pivot mounted and could be designed to operate in tension on the cloth with the action of elastic means, of pressurized fluid means, or by gravity.

1. Driving system for the cylinder cleaning assemblies of printing machines, of the type that comprise a bar (1) parallel to and close to the cylinder (D) to be cleaned and supported at its ends by shoulders (2) which also support rotatably the ends of the two spools (3, 103), the said spools being parallel to the said bar and located upstream and downstream thereof, one for supplying and the other for winding up the cloth (T) which travels over the front face of the said bar (1), which face contains a row of holes or nozzles (14) which on command uniformly wet the said cloth with the cleaning fluid before the cloth passes over the active front face (106) of a presser (6) housed in a longitudinal slot (5) in the said bar, which presser can be pushed, by linear actuators (7) consisting of compressed air cylinder and piston units, into extension in order to push a corresponding length of wetted cloth into contact with the cylinder to be cleaned, the said system being characterized in that when the plate cylinder is provided with at least one longitudinal channel (C) housing the sheet grippers (P) and when the ends of this channel have cams (Z) at the sides of the plate cylinder for contact with rollers mounted on the cleaning assembly, to ensure that when this assembly is actively working the presser and cloth do not interfere with the said grippers as they pass the said channel (C), the said shoulders (2) are mounted on a support structure in such a way as to be stationary during the work cycle of the assembly and the said cams (Z) of the cylinder (D) contact directly, or via interposed means, rollers (20, 20′) located at the ends of the presser (6), in such a way as to move only this component rather than the whole cleaning assembly, compensating means being provided to cause the active length of cloth to remain suitably tensioned in the longitudinal direction and to follow the presser's movements of extension and retraction.

2. System according to claim 1, characterized in that the end rollers (20, 20′) of the presser (6) contact pairs of pivoting levers (22, 25) pivoting on any fixed point (23, 26) and themselves each having a roller (24, 29) positioned so as to read the profile of the cams (Z) located on the sides of the plate cylinder (D), even at a suitable distance from the ends of the channel (C) containing the sheet grippers (P).

3. System according to claim 2, characterized in that the said pairs of pivoting levers (22, 25) are connected together by at least one torsion bar (31), in such a way that one lever only of each pair need to be dedicated to contacting, via a respective roller (24, 29), a cam (Z) located on one side only of the plate cylinder (D), in order to simplify the construction of the cleaning assembly and increase its versatility of use.

4. System according to claim 1, characterized in that the said cylinder and piston units (7) may be of the single acting type, with rod retraction by elastically acting means, or may be of the double acting type and in that they are connected to a compressed air supply (9), via a pressure regulator (10) and a solenoid valve (11) controlled by a small programmable processor (12) which controls the cleaning cycle of the plate cylinder (D), which extends the said linear actuators (7) to run this cycle and which at the end of the cycle retracts the said linear actuators.

5. System according to claim 4, characterized in that during the cleaning cycle of the plate cylinder (D), in order to limit the impact and the pressure against the cams (Z) of the end rollers (20, 20′) of the presser (6), suitable means may be provided to limit the pressure exerted by the said linear actuators (7), for example means acting automatically on the pressure regulator (10) and/or other suitable means acting in phase with the rotation of the said cylinder (D).

6. System according to claim 1, characterized in that the grippers (P) do not project from the channel (C) of the plate cylinder or they project a small amount and the cleaning assembly can be located very close to the said cylinder (D), with the presser (6) therefore having to make a movement of a few millimetres to travel from the rest position to the extended position and back again, including when its end rollers (20, 20′) are contacting the cams (Z) of the cylinder (D), the said compensating means, by the action of which the active length of cloth remains suitably tensioned in the longitudinal direction and promptly follows the presser's movements of extension and retraction, can make use of the longitudinal elasticity given to the cloth by its relatively slack winding onto the spools (3 and/or 103) or may otherwise make use of the action of suitable elastically acting means located between the spindle of the winding up spool (103) and its drive means, or may even make use of drive means of this type with elastic reaction.

7. System according to claim 1, characterized in that the said compensating means, by the action of which the length of active cloth remains suitably tensioned in the longitudinal direction and promptly follows the presser's movements of extension and retraction, comprise a dancer of any suitable type which accumulates a portion of the length of cloth stretched between the spools (3, 103) and which can be located upstream or downstream of the presser (6).

8. System according to claim 7, characterized in that the dancer consists of a beam (15), of for example L section, parallel to and on the opposite side from the presser (6), which in turn contains in its lower part a plurality of suitably spaced out round sectioned holes (16) containing axially-sliding cylindrical distance pieces (17) that may for example be axially hollow, containing screws (18) which pass through corresponding holes (19) in the said beam (15), which screws connect the said beam to the rear of the body of the presser (6) so that they move as one together, arrangements being made so that when the cleaning assembly retracts wholly or partly with the presser (6) into its seat (5), the beam (15) moves away from the bar (1) and makes up the tension in the cloth, which in this way promptly follows the movement of the presser and stays in contact with its active front face (106), and vice versa, arrangements being made so that when the presser is extended against the cylinder to be cleaned, the beam (15) moves towards the bar (1) and gives up cloth to the presser, in such a way that the length of cloth stretched between the paying out and winding up spools (3, 103) is always correctly tensioned and is not subjected to anomalous longitudinal tensions, irrespective of the travel of the presser.

9. System according to claim 8, characterized in that the distance pieces (17) can slide with play in the corresponding holes (16) of the bar (1), in such a way that the presser (6) adjusts itself automatically and accurately when in contact with the plate cylinder that is to be cleaned, even if the cleaning assembly has not been set up very accurately.

10. System according to claim 8, characterized in that the assembly is set up accurately at least in terms of the presser (6) being parallel to the generatrix of the cylinder (D), some or all of the said distance pieces (17) can slide in their holes (16) with a guided action and the distance pieces may be made of a material with a low coefficient of friction and/or the said holes (16) may be fitted with bushes of a material with a low coefficient of friction or with ball recirculating bearings, to produce an efficient guidance system for the presser (6) which partly owing simply to the connection via the distance pieces (17) and the screws (18) to the beam (15) is stiffened against bending and remains perfectly straight and parallel to the generatrix of the cylinder (D), even if pressed against the latter by only two actuators (7) arranged symmetrically and at a distance from each other.

11. System according to claim 1, characterized in that the cleaning assembly is usable alternately for cleaning two neighbouring plate cylinders, its shoulders (2) are mounted on the shoulders of the printing machine or on another supporting structure, and can be rotated on command about an axis parallel to the longitudinal axis of the bar (1) as a result of the action of a suitable actuator, in such a way that the active front face (106) of the presser (6) can be correctly oriented as required against either of the two cylinders to be cleaned.
